(19) United States
(12) Patent Application Publication
(10) Pub. No.: US 2011/0064576 A1
(43) Pub. Date: Mar. 17, 2011

(54) Wind Oscillator for Power Generation

(76) Inventor: Tianshu Liu, Portage, MI (US)

(21) Appl. No.: 12/882,253

(22) Filed: Sep. 15, 2010

Related U.S. Application Data
(60) Provisional application No. 61/276,871, filed on Sep. 17, 2009.

(51) Int. Cl. F03D 5/06

(52) U.S. Cl. 416/82

(57) ABSTRACT

A wind oscillator configured for power generation is provided. The wind oscillator includes an upwardly oriented elongate rotatable support beam configured to rotate to enable the wind oscillator to be approximately oriented with respect to a wind direction, a bracket supported by the support beam, the bracket extending transversely and outward therefrom, a shaft operably connected to the bracket at a first end of the shaft, and a gear attached to a second end of the shaft. The wind oscillator further includes an oscillating arm pivotably disposed approximately atop of said support beam, wherein the shaft is disposed upon the oscillating arm, and the oscillating arm being configured to move upwardly and downwardly with respect to the support beam in a reciprocating arrangement, an elongate transverse bar supported by a first end of the oscillating arm, elongate first and second wing bars oriented transversely with respect to the elongate transverse bar, wherein the oscillating arm, the elongate transverse bar, and the wing bars are on approximately a same plane, and a leading wing rotatably connected to and extending between the first and second wing bars.

### CROSS REFERENCE TO RELATED APPLICATIONS

This application claims priority under 35 U.S.C. §119(e) to U.S. Provisional Patent Application No. 61/276,871, filed on Sep. 17, 2009, by Tianshu Liu, the entire disclosure of which is hereby incorporated herein by reference.

### FIELD OF THE INVENTION

The invention is directed to a wind oscillator for generating electrical energy.

### BACKGROUND OF THE INVENTION

Wind energy, as a major sustainable clean energy source, has recently attracted an intense amount of attention. Government and industry have aggressively pushed the development of wind turbine technology, particularly devoted to the development of a wide range of reliable wind turbines.

In the long history of the use of wind kinetic energy, horizontal-axis wind turbines (HAWT) and vertical-axis wind turbines (VAWT) have been adopted as the main designs for extracting wind energy. In particular, HAWT is predominantly used for commercial power generation. The efficiency of turbine blades has improved considerably over the years by the advent of advanced aerodynamic designs. However, the basic law that aerodynamic force is proportional to the wing area of a blade remains unchanged. Thus, it is difficult to maximize the effective aerodynamic surface of rotating blades, while maintaining the structural integrity thereof, as the size of a wind turbine increases.

For medium and large size wind turbines, to reduce the centrifugal force in rotational motion, blades are usually long and slender particularly near the tips even though they are made of light composite materials. Thus, the effective aerodynamic area is very limited near the tip of a blade where a considerable amount of aerodynamic torque is generated. In addition, to further improve the aerodynamic efficiency, a mechanical-electrical device for active pitching can be installed inside of a slender blade. This arrangement not only adds a weight penalty on a slender blade, but also increase the structural complexity and weaken the structural integrity of the blade.

Furthermore, the installation and maintenance of long slender blades in large-size HAWT and VAWT is particularly difficult, and requires special equipment that may not be easily operated in certain terrain. For example, contamination of dead bugs and birds near the leading edges of blades could reduce the aerodynamic efficiency by 50%. Cleaning the contamination on blades of a large-size HAWT is not an easy task at all. These problems become bottlenecks in the development and cost-efficient use of medium and large size wind turbines. A critical question is whether there are viable non-conventional designs that can provide the better solutions to these bottleneck problems.

### SUMMARY OF THE INVENTION

According to one aspect of the present invention, a wind oscillator configured for power generation is provided. The wind oscillator includes an upwardly oriented elongate rotatable support beam configured to rotate to enable the wind oscillator to be approximately oriented with respect to a wind direction, a bracket supported by the support beam, the bracket extending transversely and outward therefrom, a shaft operably connected to the bracket at a first end of the shaft, and a gear attached to a second end of the shaft. The wind oscillator further includes an oscillating arm pivotably disposed approximately atop of the support beam, wherein the shaft is disposed upon the oscillating arm, and the oscillating arm being configured to move upwardly and downwardly with respect to the support beam in a reciprocating arrangement, an elongate transverse bar supported by a first end of the oscillating arm, elongate first and second wing bars oriented transversely with respect to the elongate transverse bar, wherein the oscillating arm, the elongate transverse bar, and the wing bars are on approximately a same plane, and a leading wing rotatably connected to and extending between the first and second wing bars.

A wing oscillator mainly comprises a tandem of two rectangular wings mounted at the ends of a main beam arm or arm that can rotate around a pivot of a support fixed on the ground. The angles of attack of the wings can be actively controlled to obtain maximum torque from the aerodynamic forces in a range of wind speeds.

In the wind oscillator of the invention, through mechanical mechanisms, the oscillating rotational motion of the main beam arm with the tandem of wings is converted to a linear reciprocating motion and then to a circular motion to drive a generator.

Compared to conventional wind turbines, the invention has distinct advantages. The aerodynamic forces on the entire wing surfaces can be almost uniformly utilized, and the effective wing area can be easily enlarged, while the wing weight is not a critical concern in this design. Therefore, the aerodynamic efficiency is high.

In addition, rectangular shaped wings are typically used, and the structural and geometrical simplicity of the wings makes manufacturing of the wings cost-efficient. The structurally and geometrically simple wing arrangement, and mounting the major mechanical and electrical equipment on the ground, allows for easy installation and maintenance. Although the proposed research mainly targets medium and large size wind turbines, the design is also feasible for small size systems.

### BRIEF DESCRIPTION OF THE DRAWINGS

FIG. 1 is a perspective view of a first embodiment of the wind oscillator.

FIG. 2 is a simplified mechanical model of a wind oscillator.

FIG. 3 is a mechanical model showing velocity and force vectors for a wing.

FIG. 4 is a graph of angular position of a wing versus time.

FIG. 5 is a graph showing effective change in angle of attack for a wing.

FIG. 6 is a graph of normal force for an arm of a wind oscillator.

FIG. 7 is a graph of angular position of a wing as a function of wind speed at different frequencies.

FIG. 8 is a graph of mean shaft power as a function of the frequency of changing angles of attack for different wind speeds.

FIG. 9 is a graph of mean shaft power as a function of the wind speed for different frequencies of changing angle of attack.

FIG. 10 is a graph of efficiency of power generation versus wind speed.

FIG. 11 is a perspective view of a second embodiment of the invention.

Certain terminology will be used in the following description for convenience in reference only, and will not be limiting. For example, the words “upwardly”, “downwardly”, “rightwardly” and “leftwardly” will refer to directions in the drawings to which reference is made. The word “forwardly” will be used in relationship to the leading wing that is oriented toward the direction of a wind, and the word “rearwardly” will refer to the direction of the other wing spaced away from and downwind of the first wing. The words “inwardly” and “outwardly” will refer to directions toward and away from, respectively, the geometric center of the vertical support beam and designated parts thereof. Said terminology will include the words specifically mentioned, derivatives thereof, and words of similar import.

### DETAILED DESCRIPTION OF THE INVENTION

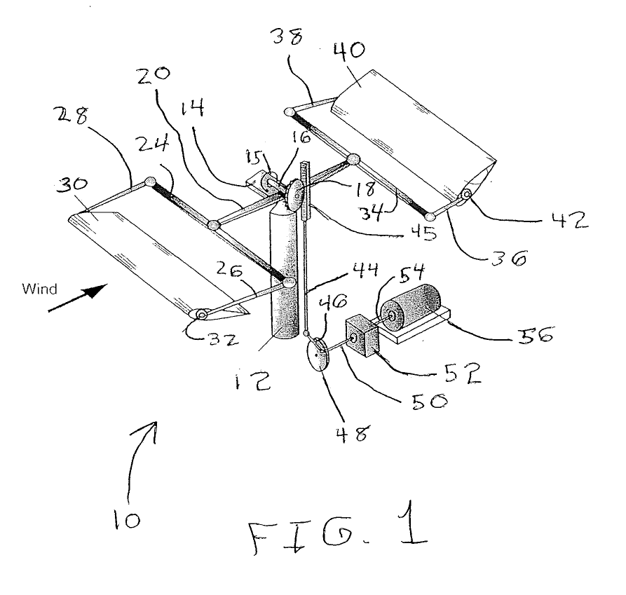

FIG. 1 shows a wind oscillator 10 including an upwardly oriented elongate rotatable support beam 12 that supports a bracket 14 that extends transversely and outwardly therefrom. The support beam 12 is generally rotatable to enable the wind oscillator 10 to remain oriented properly with respect to wind direction. A shaft 16 is joined with bracket 14 by a spring 15 disposed at a first end thereof. A second end of the shaft 16 has a toothed gear wheel 18 integrally secured thereto and rotatable therewith. The shaft 16 is disposed upon a main elongate oscillating arm 20. The oscillating arm 20 is disposed between the shaft 16 and the upward end or top of the support beam 12. The oscillating arm 20 is pivotably disposed at the top of the support beam 12 and movable upwardly and downwardly at ends thereof in a reciprocating or oscillating arrangement. The top of the support beam 12 is tapered to enable the upward and downward pivoting movement of the oscillating arm 20 disposed essentially transversely thereon.

A first end of the oscillating arm 20 supports an elongate transverse bar 24 that is transverse relative to the main arm. At each end of the transverse bar 24, elongate wing bars 26, 28 are oriented transversely with respect to the bar 24 and secured thereto. The oscillating arm 20 and bars 24, 26, 28 generally are encompassed within the same plane.

At distal ends of the wing bars 26, 28, a leading wing 30 is rotatably joined thereto and extends between the wing bars. A servo motor 32 disposed at the distal end of the first wing bar 26 is capable of rotating the wing 30. In some embodiments, a second servo motor is disposed at the distal end of the second wing bar 28 to assist in rotating or pivoting of the wing 30.

The second opposing end of the oscillating arm 20 supports another elongate transverse bar 34. At each end of the bar 34, proximal ends of elongate wing bars 36, 38 are fixed thereto. Again, the oscillating arm 20 and bars 34, 36, 38 are aligned to define a single plane.

Distal ends of the wing bars 36, 38 pivotably or rotatably support a trailing wing 40 that extends between the wing bars. A servo motor 42 at the distal end of the wing bar 36 is capable of rotating the trailing wing 40. In some embodiments, a respective second servo motor is disposed at the distal end of the wing bar 38 to further assist in rotating the trailing wing 40.

In some embodiments, the wings 30, 40 are rectangular. One or more accelerometers are provided on the oscillating arm 20.

Returning to the shaft 16 secured or fixed to the oscillating arm 14, the toothed gear wheel 18 rotates with the main arm 20 about a substantially horizontal axis to move an elongate vertically oriented rod 44 having a linear toothed gear face 46 at an upper end thereof. The rod 44 is capable of movement upwardly and downwardly in a linear, substantially vertical direction. A lower end of the elongate rod 44 has a power transfer shaft 46 attached thereto for driving a crank mechanism 48. The crank mechanism 48 is connected by a shaft 50 to a gear box 52. A gear shaft 54 connects the gear box 52 to a power generator 56.

The leading wing 30 first encounters wind directly thereon and the trailing wing 40 facing in the same direction is located behind the wing 30. The wings 30, 40 form a tandem of wings and the weights thereof are balanced on each side at a pivot point at the top of the support beam 12.

For simplicity, the airfoil section is symmetrical, and a cambered airfoil section could be used as well. The geometrical angles of attack (AoAs) of the wings 30, 40 relative to the incoming wind direction can be actively controlled by servo motors 32, 42 mounted at ¼ wing chord. The effective AoA of a wing, which is dependent on the linear velocity of the wing in the rotational motion and the incoming wind speed, is estimated based on the rotational rate and angular position of the oscillating arm 20 measured by using the accelerometers attached on the arm.

In the first half of an oscillating cycle, the effective AoAs of the wings 30, 40 are set to be positive and negative respectively such that aerodynamic lift generates a clockwise torque and motion. In the second half of the cycle, the effective AoAs are switched to the opposite signs such that counterclockwise torque and motion are generated.

The geometrical AoAs of the wings 30, 40 are controlled by a computer controlling the servo motors 32, 42. The oscillation of the tandem of wings 30, 40 is sustained in a controllable way to extract wind energy. By feedback closed-loop control, the maximum effective AoA for a wing 30, 40 before stall is maintained to achieve the largest lift magnitude in all the phases of operation. The wind direction and magnitude can be measured by a Pitot tube or other wind velocity sensor. With regard to aerodynamics, the wind oscillator 10 can be considered as a pair of suitably-coordinated flapping wings 30, 40 for extracting wind energy. Since the wing loading is typically low, the wings 30, 40 can be made of light composite materials to reduce the inertia in the control of the AoA. Rather than a computer/servo motor system, the AoAs of the wings 30, 40 could also be controlled by a mechanical system coordinated with the rotational motion of the arm 20. The major advantage of such a mechanical system is its simplicity such that servo motors and a computer are not needed.

A spring system including spring 15 constrains the angular motion of the tandem of wings 30, 40, and the spring coefficient is adjusted as a design parameter to optimize the performance of the wind oscillator 10. Gear wheel 18 and linear gear 45 transform an oscillating angular motion of the oscillating arm 20 to a linear reciprocating motion of the rod 44. The force transmitted by the rod 44 drives a shaft 46 and thus crank mechanism 48 to generate a circular motion at the angular rate of the oscillation. Then, the rotational frequency is increased, as required for generator 56 through gear box 52 and gear shaft 54.

Since the wings 30, 40 should always face directly toward the incoming wind to obtain maximum lift, yaw control is achieved by installing the wings 30, 40 and associated mechanical and electrical systems on a ground rotary table driven by a servo motor based on the measured direction of wind. Yaw control may also be achieved passively by using relatively large vertical winglets at the ends of the wings 30, 40.

The effective aerodynamic area of the rectangular wings 30, 40 in wind oscillator 10 can be considerably enlarged without serious concerns of weakening the structural integrity since the weights of the wings 30, 40 are in equilibrium with respect to the pivot point. Active control of angles of attack of the wings 30, 40 is able to maximize the aerodynamic efficiency of the wings. The aerodynamics of the oscillating rectangular wings 30, 40 and oscillating arm 20 is relatively simple for calculation and prediction. The efficiency of power generation in such a wind oscillator 10 is high, particularly at low wind speeds.

The structural and geometrical simplicity of the rectangular wings 30, 40 allows a significant reduction of cost for manufacturing of the wings. Since the rectangular wings 30, 40 are no longer slender like blades as in HAWT and VAWT arrangements, requirements in the selection of materials for the wings are more relaxed. Thus the installation and maintenance of wind oscillator 10 is much easier compared to HAWT and VAWT wind turbines, since the main components like the wings 30, 40, the gearbox 52 and the generator 56 are more accessible

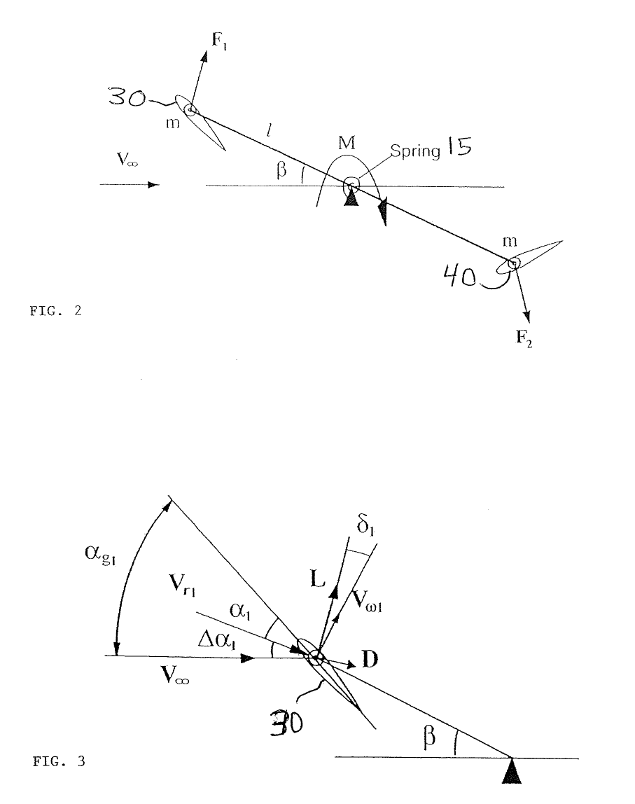

Compared to the aerodynamics of HAWT and VAWT wind turbines, a quasi-steady aerodynamic analysis of a wind oscillator 10 based on the lifting-line model for rectangular wings 30, 40 is more straightforward when the complicated wake interference of the wing 30 to the wing 40 at a crossing-over moment is not considered in a first-order analysis. FIG. 2 shows a simplified mechanical model for a wind oscillator 10 driven by the aerodynamic forces on the wings 30, 40. Note that the gravitational forces on the wings 30, 40 are not shown in FIG. 2, since they do not play a significant dynamical role when the weights of the wings are balanced. It is assumed that the masses are concentrated at the ¼ chord of the wings 30, 40 and that they are the same. The arm lengths to the wings 30, 40 on both the sides from the pivot point are the same also. As shown in FIG. 2, the motion of the wind oscillator 10 is described by the angular position β(t) that is positive when it is in the upper-half of the plane. The moment or torque around the pivot is positive when it moves clockwise. A spring system including spring 15 constrains the motion of the oscillating arm 20.

FIG. 3 shows the relevant velocity and force vectors on the wing 30. The geometrical AoA (α_{g1}) is the pitching angle of the wing-section chord line relative to the incoming wind velocity V_{∞}. Since the wing 30 moves along a circular arc around the pivot at a linear tangential velocity V₍ₜ₎ₗ, the effective AoA (α₁) of the wing 30 is the angle between the chord line and the relative velocity Vᵣ₁=V_{∞}−V₍ₜ₎ₗ. The change of AoA induced by the rotational motion of the wing 30 is given by the equation:

$$Δ α = {tan}^{- 1} [ \frac{( l / {V}_{∞} ) d β / d t cos β}{1 - ( l / {V}_{∞} ) d β / d t sin β} ] \qquad ( 1 )$$

In the equation, 1 is the arm length defined as the distance between the pivot and the c/4 of a wing. Therefore, the effective AoA is α₁=α_{g1}−Δα₁. The angle between the lift and V_{ω1} is δ₁=β−Δα₁. Similarly, for the wing 40, the induced change in AoA is:

$$Δ α = {tan}^{- 1} [ \frac{- ( l / {V}_{∞} ) d β / d t cos β}{1 + ( l / {V}_{∞} ) d β / d t sin β} ] \qquad ( 2 )$$

wherein α₂=α_{g2}−Δα₂, and δ₂=β+Δα₂.

The equation of motion for wing oscillator 10 is as follows:

$$2 {l}^{2} m \frac{{d}^{2} β}{d {t}^{2}} = l ( {L}_{1} cos {δ}_{1} - {L}_{2} cos {δ}_{2} ) + l ( {D}_{1} sin {δ}_{1} - {D}_{2} sin {δ}_{2} ) - {k}_{s} {l}_{s} β \qquad ( 3 )$$

In the above equation, m is the mass of the wing, kₛ is the spring coefficient, and lₛ is the radial distance of the spring to the pivot point.

The lifts of the wings 30, 40 are L₁=C_{L1} qᵣ₁ S_{ω} and L₂=C_{L2} qᵣ₂ S_{ω}, wherein S_{ω} is the wing platform area, qᵣ₁=0.5ρ|Vᵣ₁|² and qᵣ₂=0.5ρ|Vᵣ₂|². The quasi-steady aerodynamics is considered when the reduced frequency is sufficiently low. Typically, the reduced frequency based on the frequency of changing the AoA, wind speed and the wing chord is less than 0.2. Therefore, the quasi-steady assumption is reasonable as a first-order approximation. The unsteady aerodynamic models will be used for further improvement. Before stall, the lift coefficients for both the wings 30, 40 are given by C_{L}=α[α(t)−α_{L=0}] for α<αₛ, wherein αₛ is the stall AoA. According to the lifting-line model, the lift slope is:

$$a = \frac{{a}_{0}}{1 + ( {a}_{0} / π AR ) ( 1 + τ )}$$

wherein α₀=2π, AR is the wing aspect ratio and τ is a parameter related to the wing platform. After stall (α>αₛ), an empirical model for C_{L} is as follows:

$${C}_{L} = \frac{{C}_{D , max}}{2} sin ( 2 α ) + {K}_{L} \frac{{cos}^{2} α}{sin α} \qquad ( 4 )$$

wherein K_{L}=(C_{L,s}−C_{D,max} sin αₛ cos αₛ)sin αₛ/cos² αₛ. The relative dynamic pressures for the wings 30, 40 are as follows:

$${q}_{r 1} = \frac{1}{2} ρ {V}_{r 1}^{2} = \frac{1}{2} ρ [ {( {V}_{ω 1} cos β )}^{2} + {( {V}_{∞} - {V}_{ω 1} sin β )}^{2} ] \\ {q}_{r 2} = \frac{1}{2} ρ {V}_{r 2}^{2} = \frac{1}{2} ρ [ {( {V}_{ω 2} cos β )}^{2} + {( {V}_{∞} + {V}_{ω 2} sin β )}^{2} ] \qquad ( 5 )$$

wherein V_{ω1}=V_{ω2}=ldβ/dt. The drag of the wings 30, 40 are D₁=C_{D1}qᵣ₁S_{ω} and D₂=C_{D2} qᵣ₂S_{ω}. For α<αₛ, C_{D}=C_{D0}+KC_{L}², wherein K=(πeAR)⁻¹. For α>αₛ, C_{D}=C_{D,max} sin² α+K_{D} cos α, wherein K=(C_{D,s}−C_{D,max} sin² αₛ)/cos αₛ and C_{D,max}=1.11_{—}0.018AR for AR≦50.
Further, the equation of motion is as follows:

$$\frac{{\partial }^{2} β}{\partial {t}^{2}} = \frac{1}{2 {τ}_{1}^{2}} ( {C}_{L 1} {γ}_{1} cos {δ}_{1} - {C}_{L 2} {γ}_{2} cos {δ}_{2} ) + \frac{1}{2 {τ}_{1}^{2}} ( {C}_{D 1} {γ}_{1} sin {δ}_{1} - {C}_{D 2} {γ}_{2} sin {δ}_{2} ) - \frac{1}{2 {τ}_{2}^{2}} {β}^{′} \qquad ( 6 )$$

wherein the timescales are τ₁={square root over (lm/(S_{ω}q_{∞}O)} and τ₂={square root over (l²m/(kₛlₛO)}, γ₁=1+λ²−2λ sin β and γ₂=1+λ²+2λ sin β, and λ=(l/V_{∞})dβ/dt is the tip-speed ratio.

Eq. (6) above is a non-linear ordinary differential equation. The first term in the right-hand side of Eq. (6) is a driving term from the aerodynamic lift in which C_{L1} and C_{L2} always have opposite signs by actively controlling AoAs of the wings 30, 40 through the servo motors 32,42. The second term is a term related to the drags, which is small since the effects of the drags from the wings 30, 40 tend to cancel out each other. The third term is a stiffness term associated with the spring 15. Eq. (6) is solved numerically by using the four-order Runge-Kutta method with the initial conditions β=0 and dβ/dt=0 at t=0. The instantaneous mechanical power transmitted to the shaft 54 for the generator 56 is P(t)=2πfTᵣηₜᵣₐₙₛ, wherein Tᵣ=2l|L₁ cos δ₁+D₁ sin δ₁| is the torque, f is the frequency of oscillation, and ηₜᵣₐₙₛ is the efficiency of the mechanical system in power transfer. Further, the power is rewritten as follows:

P(t)=4πflq_{∞}s_{ω}ηₜᵣₐₙₛγ₁|C_{L1} cos δ₁+C_{D1}γ₂ sin δ₁| (7)

The mean power (P) is obtained by averaging Eq. (7) over a time period. The efficiency of power generation is estimated, which is defined as η= [symbol] P [symbol] /P_{flow}, wherein P_{flow}=q_{∞}V_{∞}S_{actuator}, wherein S_{actuator} is the actuator area that should be suitably defined. Thus, the efficiency is:

$$η = 4 π ( \frac{f 1}{{V}_{∞}} ) ( \frac{{S}_{ω}}{{S}_{actuator}} ) {η}_{trans} 〈 {γ}_{1} \vert {C}_{L 1} cos {δ}_{1} + {C}_{D 1} {γ}_{2} sin {δ}_{1} \vert 〉 \qquad ( 8 )$$

Eq. (8) indicates that the efficiency is proportional to the tip speed ratio fl/V_{∞} and the ratio between the wing area and the actuator area S_{actuator}. Here, for a wind oscillator 10 (or a wind rotor), the actuator area S_{actuator}=2Lb+cb/2 is the vertically-projected area, where L is the arm length, b is the wing span, and c is the wing chord.

In order to clearly understand the physical meanings of the terms in Eq. (6), a model equation in a limiting case is given through linearization of Eq. (6). For |β|<<1 and |dβ/dt|<<1, Eq. (6) is simplified as

$$\frac{{d}^{2} β}{d {t}^{2}} = ( \frac{1}{2 {τ}_{1}^{2}} - \frac{{Ka}^{2} {α}_{L = 0}}{{τ}_{1}^{2}} β ) ( {α}_{g 1} - {α}_{g 2} - 2 \frac{1}{{V}_{∞}} \frac{d β}{d t} ) + \frac{{Ka}^{2}}{2 {τ}_{1}^{2}} β ( {a}_{g 1}^{2} - {a}_{g 2}^{2} ) - \frac{1}{2 {τ}_{2}^{2}} β \qquad ( 9 )$$

Further, for α_{L=0}=0 and α_{g1}=−α_{g2}, Eq. (8) becomes a linear vibration equation as follows:

$$\frac{{d}^{2} β}{d {t}^{2}} = \frac{1}{{τ}_{1}^{2}} ( {α}_{g 1} - \frac{1}{{V}_{∞}} \frac{d β}{d t} ) - \frac{1}{2 {τ}_{2}^{2}} β \qquad ( 10 )$$

The forcing term in Eq. (10) is α_{g1}/τ₁². The damping term is directly proportional to the induced change in AoA Δα₁≈(l/V_{∞})dβ/dt=λ, and the damping coefficient is τ₃/τ₁², wherein τ₃=1/V_{∞} is another timescale. The natural circular frequency is ωₙ=(\sqrt{2}τ₂)⁻¹. To achieve the maximum lift, the effective AoA (α₁=α_{g1}−Δα₁ or α₂=α_{g2}−Δα₂) should be maintained at the AoA at max(C_{L}) denoted by α_{max(L)} in all the phases. The simplest waveform for the effective AoA is a square waveform jumping between −α_{max(L)} and α_{max(L)}. For example, α₁=±α_{max(L)} for the wing 30, wherein the positive and negative signs are taken when the wing moves clockwise and counterclockwise, respectively. The geometrical AoA of the wing 30 should be adjusted in a feedback control based on α_{g1}=±α_{max(L)}+(l/V_{∞})dβ/dt for the linearized case and α_{g1}=±α_{max(L)}+Δα, for a general case. According to Eq. (10) above, such a control strategy for compensating the induced change in AoA essentially eliminates the damping term in the vibration system.

On embodiment of a wind oscillator 10 is discussed below to demonstrate its performance. Table 1 below lists design parameters for one embodiment of a medium-size wind oscillator.

TABLE 1
Design Parameters for a Medium-Size Wind Oscillator

| Components | Design Values |
|---|---|
| Single wing mass (kg) | 100 |
| Arm length (m) | 8 |
| Single wing area (m²) | 40 |
| τ | 0.2 |
| Oswald efficiency | 0.8 |
| Zero-lift AoA (degrees) | 0 |
| Stall AoA (degrees) | 12 |
| Zero-lift drag coefficient | 0.05 |
| for the wing 30 | |
| Zero-lift drag coefficient | 0.05 |
| for the wing 40 | |
| Air density (kg/m³) | 1.21 |
| Spring constant 1 (N − s) | 30000 |
| Spring constant 2 (N − s) | 200000 |
| 1ₛ (m) | 0.5 |
| CL at stall AoA | 1.5 |
| CD at stall AoA | 0.2 |
| Amplitude of AoA control | 12 |
| (degrees) | |
| ηₜᵣₐₙₛ | 0.8 |

Wind speed and the frequency of changing AoA are adjustable parameters. The single wing mass is 100 kg, which could be reduced by using light materials. Wing weight does not play a critical role in the dynamics of wind oscillator 10 when the wings 30, 40 are in balance. However, wing mass may affect the actuating power required for controlling the AoAs of the wings 30, 40. The single wing area is 40 m², which could be achieved by using a multiple-wing configuration. A double-spring system is used such that the spring coefficient is kₛ=30000 N-s form |β|<10° and kₛ=20000 N-s for |β|>10°. Eq. (6) with the initial conditions β=0 and dβ/dt=0 is solved numerically by using the four-order Runge-Kutta method.

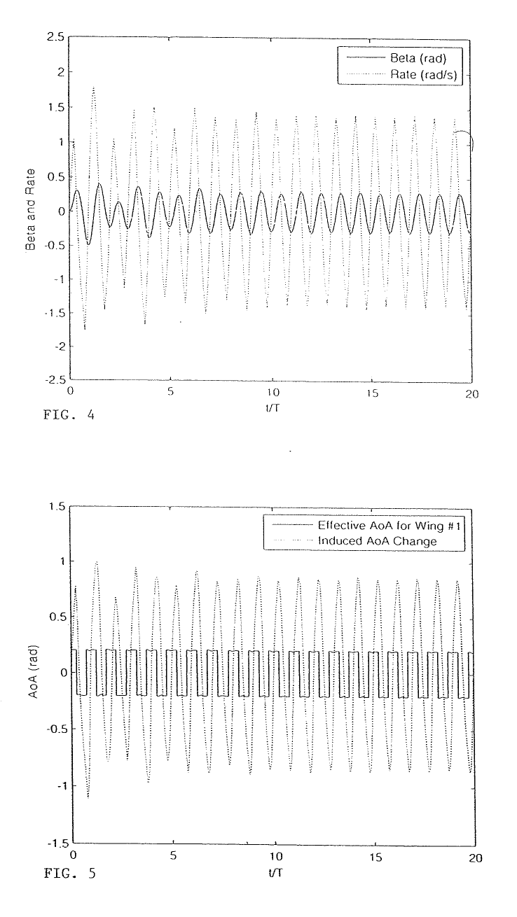

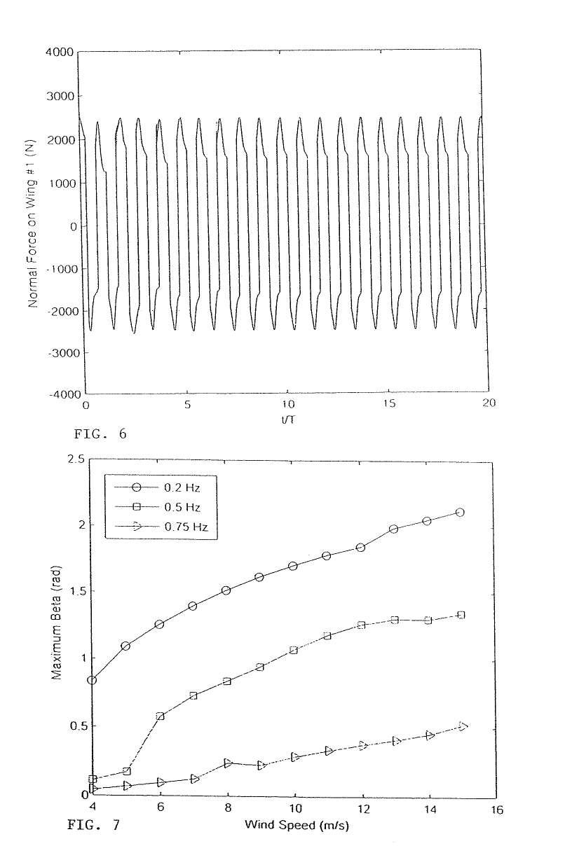

As a typical case, FIG. 4 shows the angular position, β(t) and dβ/dt for a wind speed of 10 m/s and f=0.7 Hz. In this case, the induced change in AoA is compensated through a feedback loop such that the effective AoA has a square waveform varying between the positive and negative α_{max(L)} to achieve maximum lift. FIG. 5 shows the induced change in AoA and the effective AoA after compensating the induced AoA change for the wing 30. It can be seen that the induced change in AoA is considerably large and will alter a prescribed waveform of the geometrical AoA if it is not compensated for by a feedback control.

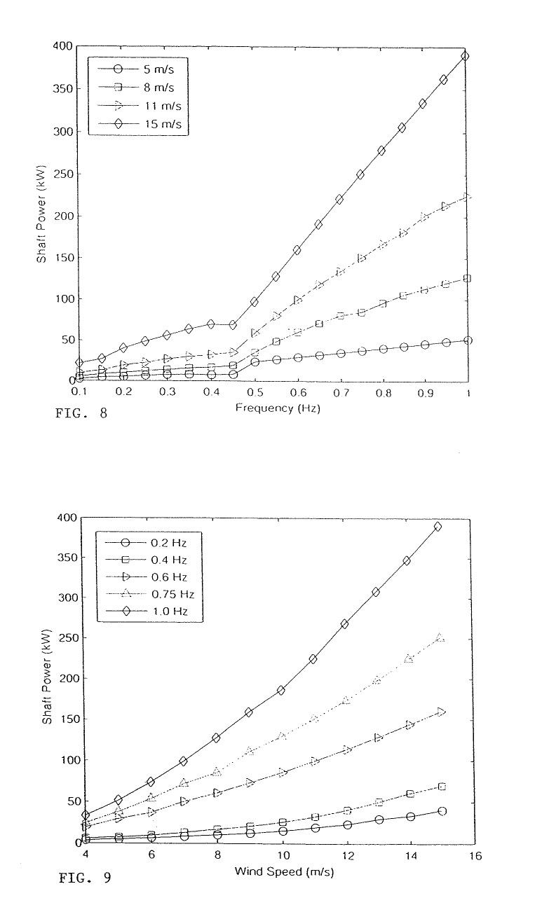

The instantaneous normal force on the leading wing 30 is shown in FIG. 6. FIG. 7 shows the maximum angular position that gives the range of the oscillation. FIG. 8 shows the mean shaft power as a function of the frequency of changing AoA for different wind speeds. The mean power increases faster when the frequency is larger than 0.45 Hz. FIG. 9 shows an increase of the mean shaft power with increasing the wind speed for different frequencies of changing AoA, which is similar to a HAWT arrangement before stall. These results indicate that the output shaft power is 40-80 kW for the frequency of 0.75 Hz in a wind range of 4-8 m/s that covers the major portion of the distribution of wind speeds. This wind oscillator design is basically equivalent to a medium-scale wind turbine.

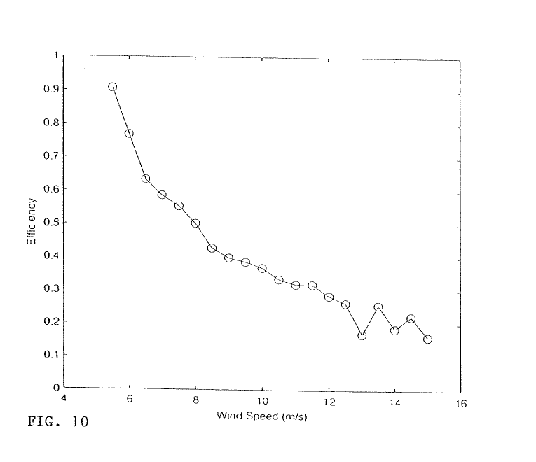

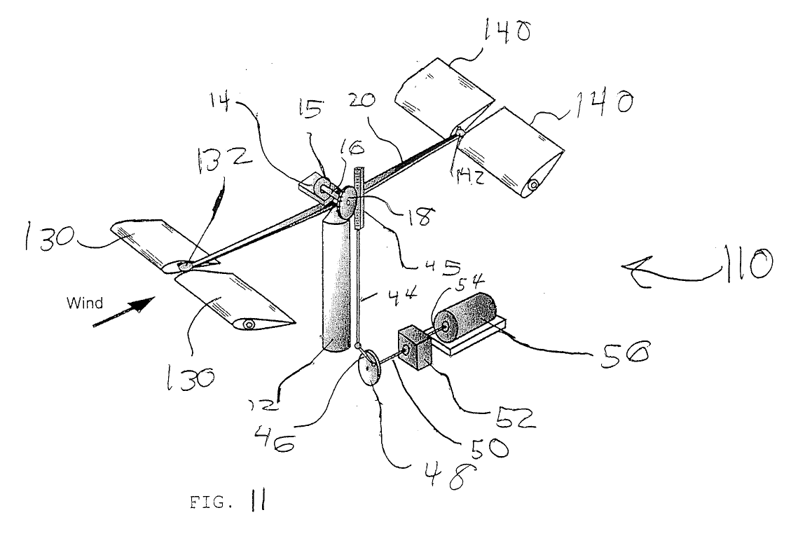

FIG. 10 shows the efficiency of generation of power in a wind oscillator for f=0.7 Hz. As indicated in FIG. 10, for a fixed oscillating frequency, the efficiency decreases as the wind speed increases. According to Eq. (8), the efficiency decrease occurs because the tip speed ratio fl/V_{∞} is decreased. To maintain a constant efficiency, the frequency of oscillation should be proportionally increased with the wind speed.

FIG. 11 illustrates a second embodiment of the wing oscillator. Like reference numerals are provided wherein the components or elements are generally the same as in the embodiment of FIG. 1.

The wing oscillator 110 operates or functions in essentially the same manner as the embodiment shown in FIG. 1. A pair of wing elements 130, however, form the leading wing. A distal end of oscillating arm 20 connects to and supports wing elements 130, which are both rotatable together by servo motor 132 located at the end of arm 20.

Likewise, the trailing wing in FIG. 11 is also formed by a pair of wing elements 140 that are pivotably secured at the opposing end of arm 20. Again, servo motor 142 is provided for controlling the rotation or pivoted position of the wing elements 140.

In conclusion, the FIG. 11 embodiment operates in a similar manner to the embodiment of FIG. 1. Allowance, however, is typically made for the gaps between the respective wing elements.

Although a particular preferred embodiment of the invention has been disclosed in detail for illustrative purposes, it will be recognized that variations or modifications of the disclosed apparatus, including the rearrangement of parts, lie within the scope of the present invention.

1. A wind oscillator configured for power generation, said wind oscillator comprising:
an upwardly oriented elongate rotatable support beam, configured to rotate to enable the wind oscillator to be approximately oriented with respect to a wind direction;
a bracket supported by said support beam, said bracket extending transversely and outward therefrom;
a shaft operably connected to said bracket at a first end of said shaft;
a gear attached to a second end of said shaft;
an oscillating arm pivotably disposed approximately atop of said support beam, wherein said shaft is disposed upon said oscillating arm, and said oscillating arm being configured to move upwardly and downwardly with respect to said support beam in a reciprocating arrangement;
an elongate transverse bar supported by a first end of said oscillating arm;
elongate first and second wing bars oriented transversely with respect to said elongate transverse bar, wherein said oscillating arm, said elongate transverse bar, and said wing bars are on approximately a same plane; and
a leading wing rotatably connected to and extending between said first and second wing bars.
